(19) United States
(12) Patent Application Publication
(10) Pub. No.: US 2012/0172060 A1
(43) Pub. Date: Jul. 5, 2012

(54) DATA TRANSMISSION METHOD AND MOBILE DEVICE ADAPTED THERETO

(75) Inventors: Ni Yong Qing, Nam-gu (KR); Kwang Bin Lee, Suwon-si (KR); Seong Won Im, Seo-gu (KR); Sang Hun Lee, Suseong-gu (KR); Jong Moon Choi, Suwon-si (KR); Sang Woo Park, Seongnam-si (KR)

(73) Assignee: SAMSUNG ELECTRONICS CO., LTD., Suwon-si (KR)

(21) Appl. No.: 13/340,996

(22) Filed: Dec. 30, 2011

(30) Foreign Application Priority Data
Jan. 4, 2011 (KR) 10-2011-0000608

(51) Int. Cl. H04W 24/00

(52) U.S. Cl. 455/456.6

(57) ABSTRACT

A method and a mobile device are adapted to transmit data through short-range communication based on movement of the mobile device. External mobile devices near the mobile device are searched. Location information for each external mobile device found near the mobile device is acquired. Data to be transmitted is set. The movement of the mobile device is recognized. At least one target mobile device is set to receive data, based on the movement of the mobile device and the acquired location information of the found external mobile devices. And the data is transmitted to the at least one target mobile device.

### CROSS-REFERENCE TO RELATED APPLICATION(S) AND CLAIM OF PRIORITY

The present application claims priority under 35 U.S.C. §119(a) to a Korean Patent Application filed in the Korean Intellectual Property Office on Jan. 4, 2011 and assigned Serial No. 10-2011-0000608, the contents of which are herein incorporated by reference.

### TECHNICAL FIELD OF THE INVENTION

This invention relates to data transmission systems, and more particularly, to a method for transmitting data in a mobile device via short-range communication and by recognizing the movement of the mobile device. The invention is also related to a system adapted to the data transmission method.

### BACKGROUND OF THE INVENTION

Mobile devices are widely used because they can be easily carried and provide a variety of functions such as a voice call function. Mobile devices serve as multimedia communication devices because they can transmit data and also provide various additional services.

Mobile device users can transmit data, such as messages, contents files, and such, to called parties via their mobile devices by selecting data to be transmitted and entering called parties' phone numbers or ID's to their mobile devices. These processes must be performed although the called parties are near the calling users. When the calling users do not know the called parties' phone numbers, they must first ask the called parties for their phone numbers. The calling users may then enter the called parties' phone numbers into their mobile devices and transmit messages to the called parties' mobile devices. This inconveniences the mobile device users.

In particular, when a mobile device user wants to send his/her electronic business card (e-business card) to multiple people, conventional data transmission system requires for the user to first input all of the called parties' phone numbers to his/her mobile device.

New systems are required to allow users to easily transmit data, such as messages, contents files, and such, from their mobile devices to external mobile devices.

### SUMMARY OF THE INVENTION

To address the above-discussed deficiencies of the prior art, it is a primary object to provide a method for transmitting data in a mobile device that enhances user convenience. The invention further provides a system adapted to the data transmission method.

In accordance with an embodiment of the invention, the invention provides a data transmission method in a mobile device. External mobile devices near the mobile device are searched. Location information for each external mobile device found near the mobile device is acquired. Data to be transmitted is set. A movement of the mobile device is recognized. At least one target mobile device is set to receive the data, based on the movement of the mobile device and the acquired location information of at the found external mobile devices. And data is transmitted to the at least one target mobile device.

In accordance with an embodiment of the invention, the invention provides a mobile device. the mobile device includes a short-range communication unit, a location measurement module, a motion sensing unit, and a controller. The short-range communication unit searches for external mobile devices near the mobile device, acquires location information for each external mobile device found near the mobile device, and transmits data to at least one target mobile device. The location measurement module measures a current location of the mobile device. The motion sensing unit senses a movement of the mobile device. And the controller sets the data to be transmitted, and sets the at least one target mobile device from among the found external mobile devices to receive the data based on the movement of the mobile device and the acquired location information of the found external mobile devices.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic block diagram of a mobile device 100 according to an embodiment of the invention;

FIG. 2 illustrates a process for transmitting data in a mobile device 100, according to an embodiment of the invention;

FIG. 3 illustrates a process for acquiring information regarding the location of an external mobile device according to an embodiment of the invention;

FIG. 4 illustrates a signal flow diagram of a process where a mobile device 100 receives the location information from an external mobile device, according to an embodiment of the invention;

FIG. 5 illustrates a process for setting a data transmission mode and data to be transmitted according to an embodiment of the invention;

FIG. 6 illustrates a process for setting a target mobile device to receive data according to an embodiment of the invention;

FIGS. 7A and 7B illustrate a user's motions applied to a mobile device 100 according to an embodiment of the invention; and

FIGS. 8A and 8B illustrate views for setting a target mobile device according to the movement of a mobile device 100.

### DETAILED DESCRIPTION OF THE INVENTION

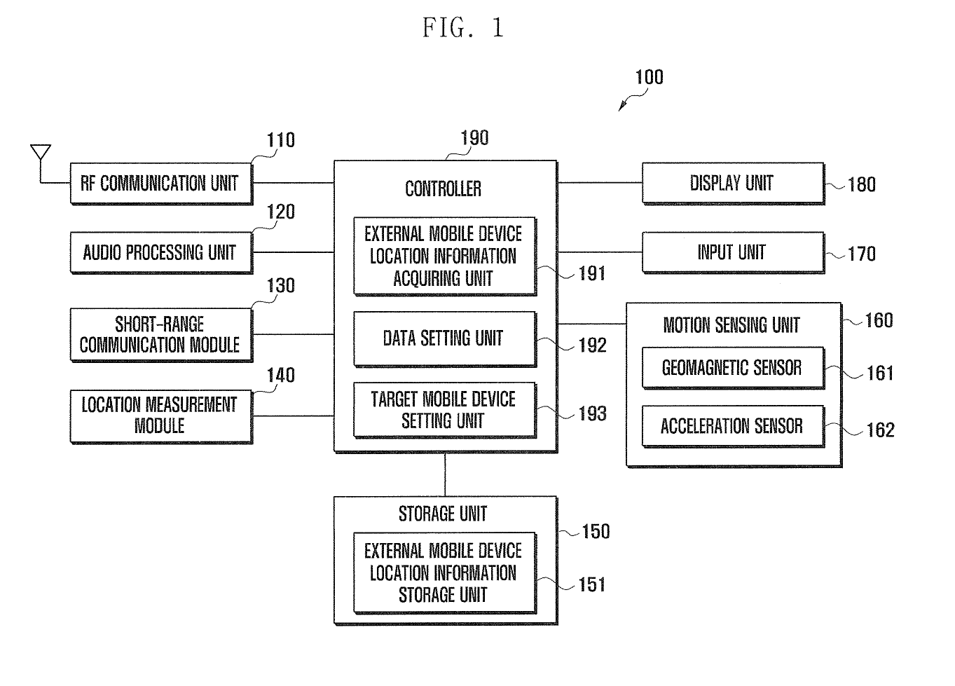

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. In the following embodiments of the invention, the term ‘data’ refers to a concept that includes all data that can be transmitted between mobile devices, for example, messages, contents files, and such.

The term ‘data sharing mode’ refers to one of the function modes in a mobile device that transmits/receives data to/from an external mobile device via short-range communication and by recognizing the motion applied thereto.

FIG. 1 illustrates a schematic block diagram of a mobile device 100 according to an embodiment of the invention. The mobile device 100 includes an RF communication unit 110, an audio processing unit 120, a short-range communication module 130, a location measurement module 140, a storage unit 150, a motion sensing unit 160, an input unit 170, a display unit 180 and a controller 190.

The RF communication unit 110 transmits/receives data, via RF communication, between the mobile device 100 and other external systems. The RF communication unit 110 includes an RF transmitter for up-converting the frequency of signals to be transmitted and amplifying the signals and an RF receiver for low-noise amplifying received RF signals and down-converting the frequency of the received RF signals. The RF communication unit 110 receives data via an RF channel and outputs it to the controller 190. The RF communication unit 110 also transmits data, output from the controller 190, via the RF channel.

The audio processing unit 120 includes coders and decoders (CODECs). The CODECs are comprised of a data CODEC for processing packet data, and such, and an audio CODEC for processing audio signals, such as voice signals, and such. The audio CODEC converts digital audio signals into analog audio signals and outputs them via a speaker. The audio CODEC also converts analog audio signals, received via a microphone, into digital audio signals.

The short-range communication module 130 directly communicates with external mobile devices without the use of a base station. The short-range communication module 130 may be implemented with a variety of communication modules such as a Bluetooth, a WiFi, a Zigbee, an infrared, a Near Field Communication (NFC), a Radio Frequency Identification (RFID), and such. In an embodiment of the invention, the short-range communication module 130 searches for external mobile devices near the mobile device 100 and connects to the searched external mobile device. The short-range communication module 130 transmits a location information request message to the connected external mobile device, and receives the location information. The short-range communication module 130 transmits data to a target mobile device according to an instruction of the controller 190.

The location measurement module 140 measures a location of the mobile device 100. The location measurement module 140 may be implemented with a Global Positioning System (GPS) module. The GPS module receives GPS signals from GPS satellites and measures the current location of the mobile device 100 using the signals. Although the location measurement module 140 can measure the current location of the mobile device 100 using only the GPS signals, it can also do so via an Assisted-GPS (A-GPS). The A-GPS measures the current location of a mobile device by using distance and a radio wave measured value between the mobile device and its adjacent mobile communication base station as well as GPS signals. When the location measurement module 140 measures the current location of the mobile device 100 based on the radio waves between the mobile device 100 and a number of base stations adjacent thereto, it can use trilateration. Alternatively, the location measurement module 140 may also be implemented with a Wi-Fi module. In that situation, when the mobile device 100 connects to an Access Point (AP), the location measurement module 140 can measure the current location of the mobile device 100 using the location information regarding the AP.

The storage unit 150 stores programs for operating the mobile device 100 and data generated when the programs are executed. The storage unit 150 is comprised of a program storage area and a data storage area.

The program storage area stores all programs for controlling the operation of the mobile device 100 and an operating system (OS) for booting the mobile device 100. The program storage area also stores an application program for playing back multimedia contents, and such. The program storage area further stores application programs for optional functions such as a camera function, audio reproduction function, photograph or video playback, and such. The data storage area stores data generated when the mobile device 100 is used, for example, images, video, phone book, audio data, and such.

In an embodiment of the invention, the storage unit 150 stores data regarding distance values corresponding to the strength levels of motions of the mobile device 100.

The storage unit 150 includes an external mobile device location information storage unit 151 that stores location information and identification-information regarding an external mobile device that is connected to the mobile device 100 via short-range communication. The external mobile device location information storage unit 151 stores azimuths and distances according to the external mobile devices that are calculated, based on the current location of the mobile device 100, by an external mobile device location information acquiring unit 191, which will be described later.

The motion sensing unit 160 senses a user's motions applied to the mobile device 100. The motion sensing unit 160 includes a geomagnetic sensor 161 and an acceleration sensor 162.

The geomagnetic sensor 161 is used to measure the direction of the movement of the mobile device 100. The geomagnetic sensor 161 senses the terrestrial magnetism of the earth and provides it to measure an azimuth. When the user applies motion to the mobile device 100, the geomagnetic sensor 161 senses the change in the azimuth of the mobile device 100.

The acceleration sensor 162 is used to measure the strength level of motion of the mobile device 100. When the user applies motion to the mobile device 100, the acceleration sensor 162 senses the change in the acceleration with respect to x-, y- and z-axes for the user's applied motion, and then provides them for measuring the strength level of motion of the mobile device 100.

The motion sensing unit 160 creates data regarding the strength level of motion and the movement direction of the mobile device 100 and outputs it to a target mobile device setting unit 193 which will be described later.

The motion sensing unit 160 may include a gyroscope. The gyroscope is a module that can measure the rotation and tilt of the mobile device 100 and transmit data regarding the rotation direction and the degree of tilt of the mobile device 100 to the target mobile device setting unit 193.

The input unit 170 generates key signals for controlling the operations of the mobile device according to user's key operations, and outputs them to the controller 190. The input unit 170 is implemented with various types of keypads including numerical keys, alphabetical keys, and directional keys, for example a 3×4 keypad, a QWERTY keypad, and such. The input unit 170 is also implemented with a touch screen. The input unit 170 is further implemented with a button key, a jog key, a wheel key, and such. The input unit 170 creates input signals for executing applications of the mobile device 100 according to a user's inputs, and outputs them to the controller 190. Examples of the applications are a call function, an audio playback function, a video playback function, an image display function, a camera function, a DMB broadcast view function, and such. In an embodiment of the invention, the input unit 170 creates instruction signals for activating a data sharing mode and for setting a data transmission mode, and data to be transmitted, and then outputs them to the controller 190.

The display unit 180 may be implemented with a Liquid Crystal Display (LCD), an Organic Light Emitting Diode (OLED), an Active Matrix Organic Light Emitting Diodes (AMOLED), and such. The display unit 180 displays menus, input data, function-setting information, and addition information. For example, the display unit 180 displays a booting screen, an idle screen, a menu screen, a call screen, and application executing screens of the mobile device. In an embodiment of the invention, the display unit 180 also displays menu screens for setting a data sharing mode, for writing data, for selecting data, and for setting a data transmission mode.

The controller 190 controls the operation of the components in the mobile device 100. The controller 190 includes an external mobile device location information acquiring unit 191, a data setting unit 192, and a target mobile device setting unit 193.

The external mobile device location information acquiring unit 191 acquires location information regarding an external mobile device near the mobile device 100, and stores it in the external mobile device location information storage unit 151. The external mobile device location information acquiring unit 191 transmits a location information request message to at least one external mobile device located near the mobile device 100 via the short-range communication unit 130, and receives information regarding the location where a corresponding external mobile device is currently located from the external mobile device. The external mobile device location information acquiring unit 191 controls the short-range communication unit 130 to measure the current location of the mobile device 100. The external mobile device location information acquiring unit 191 calculates a distance and an azimuth of at least one external mobile device with respect to the location of the mobile device 100, using the received information regarding the current location of the external mobile device and the information regarding the measured current location of the mobile device 100. The external mobile device location information acquiring unit 191 then stores, in the external mobile device location information storage unit 151, the azimuths and distances according to at least one or more external mobile devices that are calculated, based on their identification information.

The data setting unit 192 sets data to be transmitted to an external mobile device, and a data transmission mode. When the user writes new data or selects stored data, the data setting unit 192 sets the written or selected data as data to be transmitted. After that, the data setting unit 192 controls the display unit 180 to display a data transmission mode setting menu. The data transmission mode setting menu includes single and multi modes. In the single mode, the mobile device 100 transmits data to one external mobile device. In the multi mode, the mobile device 100 transmits data to a number of external mobile devices. When the data setting unit 192 receives a signal to select a single or multi mode via the input unit 170, it sets a data transmission mode according to the user's selected signal.

The target mobile device setting unit 193 sets a target mobile device to receive data. When the user applies motion to the mobile device 100, the target mobile device setting unit 193 measures the movement direct ion of the mobile device 100 via the motion sensing unit 160, and sets an external mobile device located in the sensed movement direction as a target mobile device.

In an embodiment of the invention, when the mobile device 100 experiences a user's applied motion, the target mobile device setting unit 193 measures the direction and strength level of motion of the mobile device 100 via the motion sensing unit 160, and detects an external mobile device in the measured direction of motion. The target mobile device setting unit 193 then determines whether there are two or more detected external mobile devices. When the target mobile device setting unit 193 ascertains that there are two or more detected external mobile devices, it sets, as a target mobile device, the external mobile devices that are located at a distance corresponding to the measured strength level of motion. In contrast, when the target mobile device setting unit 193 ascertains that there is one detected external mobile devices, it sets the determined external mobile device as a target mobile device.

When the mobile device 100 experiences the motion input by the user, the target mobile device setting unit 193 measures the strength level and the direction of motion of the mobile device 100 via the motion sensing unit 160 and determines whether the measured range of motion is equal to or greater than a preset range of azimuth. When the target mobile device setting unit 193 ascertains that the measured range of motion is equal to or greater than a preset range of azimuth, it determines whether the data transmission mode is set to a multi mode. When the target mobile device setting unit 193 ascertains that the data transmission mode is set to a multi mode, it sets, as a target mobile device, at least one external mobile device that is in the range of motion. In contrast, when the target mobile device setting unit 193 ascertains that the data transmission mode is set to a single mode, it sets, as a target mobile device, one of the determined external mobile devices that is closest to the mobile device 100.

The configuration of the mobile device 100 has been described. The following description provides the method for transmitting data via the mobile device 100.

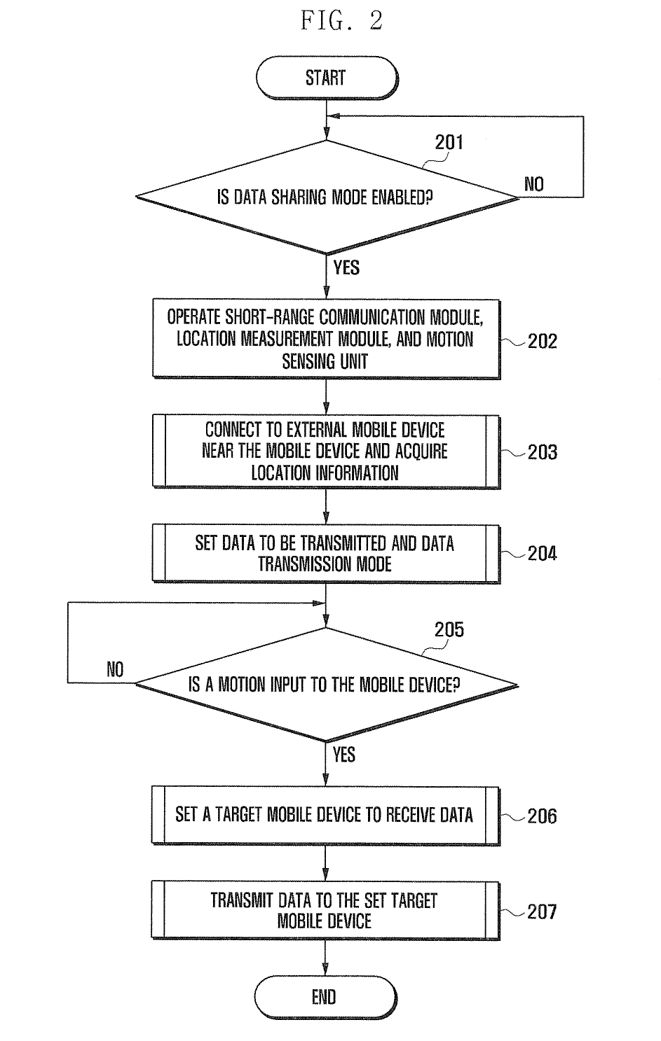

FIG. 2 illustrates a process for transmitting data in a mobile device 100, according to an embodiment of the invention.

The controller 190 determines whether a data sharing mode is set as an active state in the mobile device 100 (block 201). In an embodiment of the invention, a ‘data sharing mode’ refers to one of the function modes for the mobile device 100 in which the mobile device 100 transmits/receives data to/from an external mobile device via short-range communication and by recognizing the motion applied to the mobile device 100. The mobile device 100 includes a menu for setting the data sharing mode. The user can set the data sharing mode to be in an active or inactive state via the data sharing mode setting menu.

When a data sharing mode of the mobile device 100 is in an active state, the controller 190 controls the short-range communication unit 130 to search for external mobile devices and to connect to the searched external mobile device. The external mobile device may be configured in substantially the same way as the mobile device 100 illustrated in FIG. 1. When the external mobile device is operated in an active data sharing mode and receives a connection request from the mobile device 100, it can automatically connect to the mobile device 100. In an embodiment of the invention, the controller 190 controls the display unit 180 to display a list of searched external mobile devices and connects to a user's selected external mobile device.

In addition, when a data sharing mode of the mobile device 100 is in an active state, the controller 190 connects to an external mobile device, and then controls the short-range communication unit 130 to transmit a location information request message thereto. When the external mobile device is operated in an active data sharing mode and receives the location information request message from the mobile device 100, it measures its current location and transmits it to the mobile device 100.

When the controller 190 ascertains that a data sharing mode is set to an active state in the mobile device 100 at block 201, it operates the short-range communication unit 130, the location measurement module 140, and the motion sensing unit 160 (block 202). When the controller 190 operates the motion sensing unit 160, the geomagnetic sensor 161 and the acceleration sensor 162 are also operated. In an embodiment, when the short-range communication unit 130, the location measurement module 140, and the motion sensing unit 160 are already being operated, block 202 may be omitted.

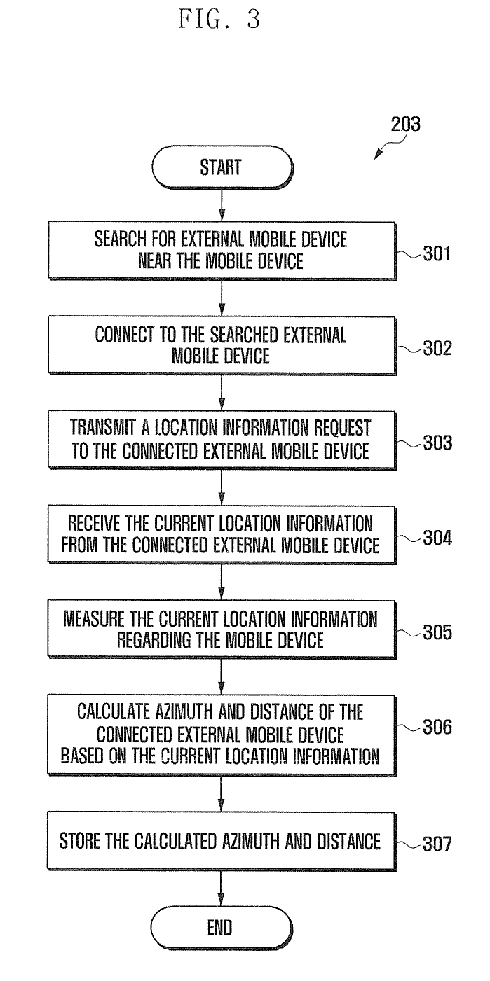

The controller 190 communicates with an external mobile device near the mobile device 100 and acquires information regarding the location of the connected external mobile device via the external mobile device location information acquiring unit 191 (block 203). Near the mobile device 100, there may be at least one external mobile device including a short-range communication unit 130 that can communicate in substantially the same way as that of the mobile device 100. The controller 190 controls the short-range communication unit 130 to search for at least one external mobile device near the mobile device 100 and connects to at least one searched external mobile device. The external mobile device location information acquiring unit 191 then acquires location information regarding at least one external mobile device, using the current location of the mobile device 100 and the current location of at least one external mobile device. The acquired location information corresponds to information regarding a distance and an azimuth with respect to the location of the mobile device 100. Block 203 will be described in detail later referring to FIG. 3.

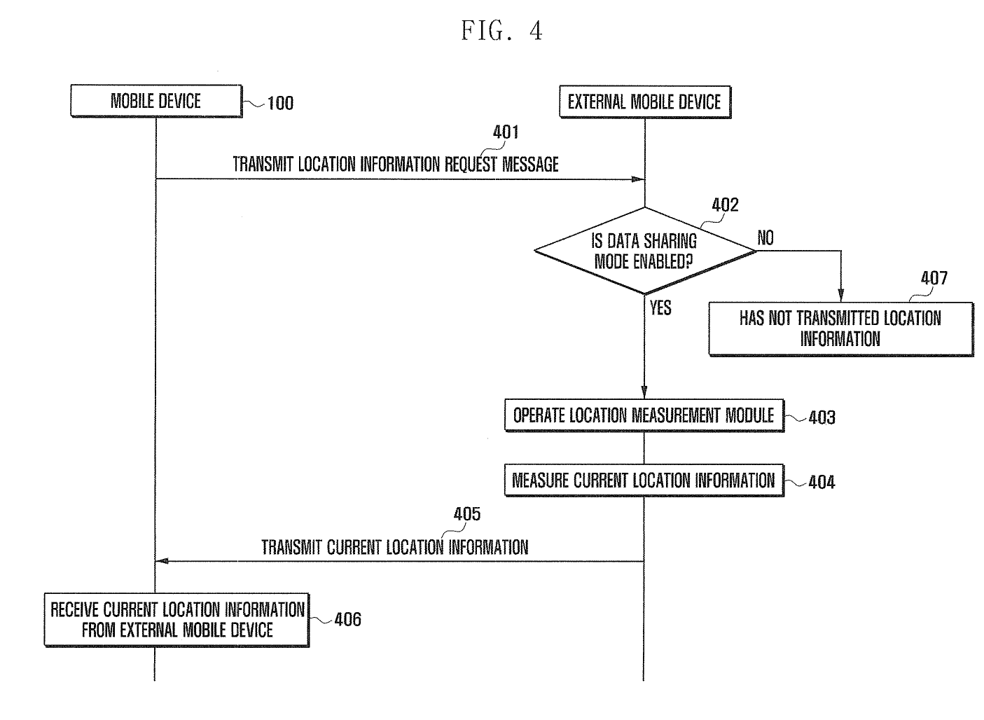

The data setting unit 192 sets data to be transmitted and a data transmission mode (block 204). The data transmission mode includes single and multi modes. In the single mode, the mobile device 100 transmits data to one external mobile device. In the multi mode, the mobile device 100 transmits data to a number of external mobile devices. Block 204 will be described in detail later referring to FIG. 4.

The controller 190 determines whether the user applies motion to the mobile device 100, via the motion sensing unit 160 (205). The controller 190 detects whether to change the azimuth of the mobile device 100, via the geomagnetic sensor 161, and also whether to change the acceleration of the mobile device 100, via the acceleration sensor 162. When a change is made in the azimuth or acceleration of the mobile device 100, the geomagnetic sensor 161 or the acceleration sensor 162 creates a sensed signal and outputs it to the controller 190. When the controller 190 receives the sensed signal from the geomagnetic sensor 161 or the acceleration sensor 162, it concludes that motion is applied to the mobile device 100.

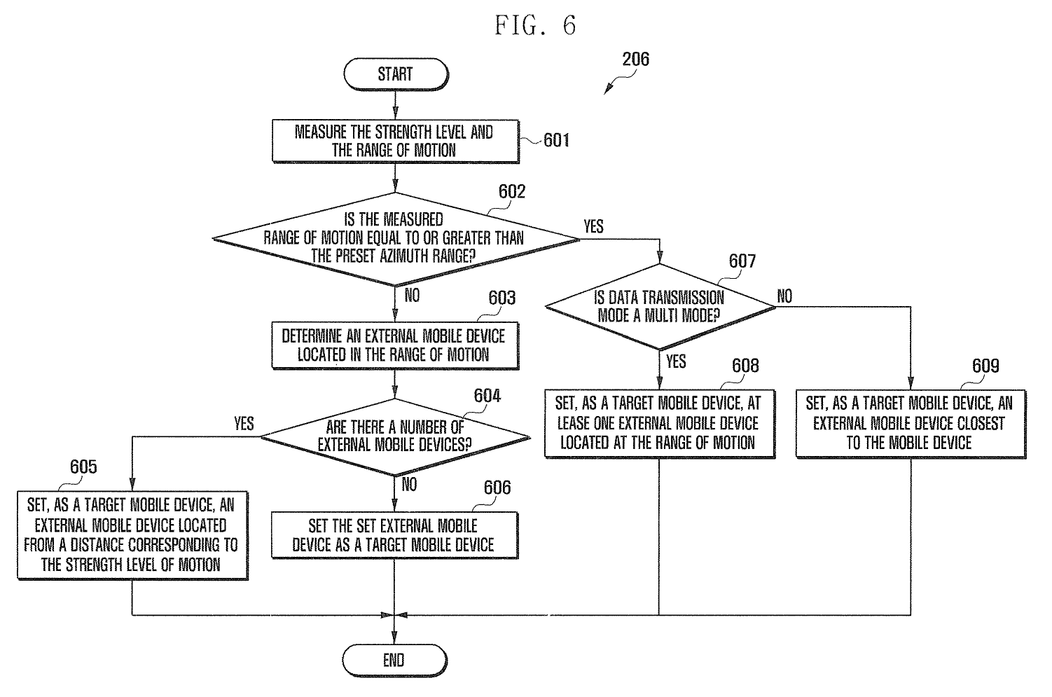

When the controller 190 detects the motion applied to the mobile device 100, the target mobile device setting unit 193 sets a target mobile device to receive data (block 206). When the mobile device 100 is connected to a number of external mobile devices, the user can select one external mobile device or a number of external mobile devices and then transmit data to the selected external mobile device(s). The target mobile device setting unit 193 sets at least one target mobile device to receive data, based on the motion applied to the mobile device 100. Block 206 will be described in detail later referring to FIG. 6.

When the target mobile device to receive data is set at block 206, the controller 190 transmits data to the target mobile device via the short-range communication unit 130 (block 207). When the data transmission mode is in single mode, the controller 190 controls the short-range communication unit 130 to transmit data to one target mobile device. In contrast, when the data transmission mode is in multi mode, the controller 190 controls the short-range communication unit 130 to transmit data to a number of target mobile devices.

When the target mobile device detects that data is being received, it receives the data and stores it in the inner storage Alternatively, when the target mobile device detects that data is being received, it displays a message asking whether to receive data. When the user selects to receive data, the target mobile device receives the data and stores it in the inner storage. In an embodiment of the invention, the target mobile device determines whether the data sharing mode is in an active state. When the target mobile device ascertains that the data sharing mode is in an active state, it can directly receive data and then store it to the inner storage, without displaying a message asking whether to receive data. In contrast, when the target mobile device ascertains that the data sharing mode is in an inactive state, it displays a message asking whether to receive data, receives data when the user selects to receive data, and stores the received data in the inner storage.

FIG. 3 illustrates a process for connecting to an external mobile device near the mobile device and acquiring location information of the external mobile device (block 203 of FIG. 2), according to an embodiment of the invention.

The controller 190 controls the short-range communication unit 130 to search for external mobile devices near the mobile device 100 (block 301). When the short-range communication unit 130 is implemented with a Bluetooth communication module, it broadcasts an inquiry signal. When at least one external mobile device receives the inquiry signal, it transmits an inquiry response signal to the mobile device 100. The inquiry response signal includes information regarding a Bluetooth device address BD_ADDR, a clock, and a class of device. When the controller 190 receives an inquiry response signal from at least one external mobile device via the short-range communication unit 130, it transmits a device name request signal thereto. At least one external mobile device receives the request signal and the device name to the mobile device 100. The controller 190 receives the device name via the short-range communication unit 130 and concludes that the external mobile device that has transmitted the device name is a searched mobile device. The controller 190 then controls the display unit 180 to display a list of searched Bluetooth devices including the device names, Bluetooth device addresses, classes of devices, and such.

In an embodiment, the short-range communication unit 130 may be implemented with a WiFi communication module that can support WiFi Peer to Peer (WiFi P2P). WFi P2P is a technology that can allow WiFi devices to directly connect to each other without an Access Point (AP). The short-range communication unit 130 scans the entire channel and transmits a probe request. External mobile devices near the mobile device 100 also scan the entire channel and then transmit probe requests. The controller 190 then enters a listen state, i.e., a standby state, with respect to a particular channel, via the short-range communication unit 130. After a certain period of time has elapsed, the controller 190 performs a search process with respect to a particular channel. During the search, the short-range communication unit 130 transmits a probe request. Likewise, the external mobile devices near the mobile device 100 are also in a listen state, i.e., a standby state, with respect to a particular channel. After a certain period of time has elapsed, the external mobile devices also perform a search process with respect to a particular channel. When the mobile device 100 in a listen state receives a probe request from an external mobile device or an external mobile device in a listen state receives a probe request from the mobile device 100, the mobile device 100 and the external mobile device perform a device search process for each other. The controller 190 controls the display unit 180 to display information regarding a searched device.

The controller 190 connects to the searched external mobile device via the short-range communication unit 130 (block 302). When the controller 190 ascertains that the data sharing mode of the mobile device 100 is an active state, it controls the short-range communication unit 130 to directly connect to at least one external mobile device searched at block 301. The controller 190 controls the display unit 180 to display a list of searched external mobile devices. When the user selects one of the external mobile devices via the input unit 170, the controller 190 controls the short-range communication unit 130 to connect to the user's selected external mobile device.

When the short-range communication unit 130 is implemented with a Bluetooth communication module, it performs pairing and connecting processes with the searched external mobile device. During the pairing process, the controller 190 controls the display unit 180 to display a PIN code input field or a message asking whether to approve a pairing process. When the user inputs a correct PIN code to the PIN code input field or selects ‘Yes’ to approve the pairing process, the short-range communication unit 130 performs the pairing process with the searched external mobile device. In an embodiment, the controller 190 can determine whether the data sharing mode is an active state. When the controller 190 ascertains that the data sharing mode is an active state, it can directly perform a pairing process with all the searched external mobile devices, without displaying a PIN code input field or a message asking whether to approve the pairing process. Likewise, an external mobile device can determine whether the data sharing mode is an active state. When the external mobile device ascertains that the data sharing mode is an active state, it can directly perform a pairing process with a searched mobile device, without displaying a PIN code input field or a message asking whether to approve the pairing process.

After performing the pairing process, the short-range communication unit 130 connects to at least one external mobile device that is paired with the mobile device 100. The connection corresponds to a process of establishing a channel to transmit/receive data between the mobile device 100 and the external mobile device.

In an embodiment, when the short-range communication unit 130 is implemented with a WiFi communication module, it performs a group formation process with at least one searched external mobile device. The short-range communication unit 130 performs a Group Owner (GO) negotiation process. The short-range communication unit 130 transmits a GO negotiation request to the searched external mobile device. The external mobile device receives the GO negotiation request and transmits a GO negotiation response to the mobile device 100. The GO negotiation request and GO negotiation response include an intent value to determine a GO. The short-range communication unit 130 and the external mobile device compare the intent values with each other, and set a mobile device with a greater intent value than the other as the GO. The short-range communication unit 130 then performs a provisioning process, exchanging credential serving as information for joining a P2P group with the external mobile device and completes the group formation process. A connection is then established between the mobile device 100 and the external mobile device.

The external mobile device location information acquiring unit 191 controls the short-range communication unit 130 to transmit a location information request message to at least one external mobile device that is currently connected to the mobile device 100 (block 303). An external mobile device receives the request message and measures its current location using the location measurement module. The external mobile device transmits the measured current location to the mobile device 100.

The external mobile device location information acquiring unit 191 receives the information regarding the current location of the external mobile device from the external mobile device currently connected to the mobile device 100, via the short-range communication unit 130 (block 304). The information regarding the current location includes latitude and longitude.

When an external mobile device receives a location information request message from the mobile device 100, it determines whether a data sharing mode is in an active state. When the external mobile device ascertains that a data sharing mode is in an active state, it transmits its current location information to the mobile device 100. This is described in detail as follows, with reference to FIG. 4.

FIG. 4 illustrates a signal flow diagram of a process in which a mobile device 100 receives the location information from an external mobile device, according to an embodiment of the invention.

The mobile device 100 transmits a location information request message 401 to an external mobile device. The external mobile device receives the location information request message 401 and determines whether a data sharing mode is in an active state (block 402). When the external mobile device ascertains a data sharing mode is in an active state at block 402, it operates the location measurement module (block 403), and measures its current location via the module (block 404). The external mobile device then transmits the current location information 405 regarding its current location to the mobile device 100. The mobile device 100 receives the current location information regarding the external mobile device (block 406). Meanwhile, when the external mobile device ascertains that the data sharing mode is in an inactive state at block 402, it does not transmit the location information to the mobile device 100 (block 407). That is, the external mobile device does not perform a location measurement process.

Referring back to FIG. 3, after receiving the current location information regarding the external mobile device via the short-range communication unit 130 at block 304, the external mobile device location information acquiring unit 191 controls the location measurement module 140 to measure the current location of the mobile device 100 (block 305). A current location includes latitude and longitude.

The external mobile device location information acquiring unit 191 calculates the azimuth and distance of at least one external mobile device currently connected to the mobile device 100, based on the measured current location of the mobile device 100 (block 306). The external mobile device location information acquiring unit 191 calculates a distance between the mobile device 100 and the external mobile device and an azimuth from the mobile device 100 to the external mobile device, using the current location of the mobile device 100 and the current location of the external mobile device. For example, the external mobile device location information acquiring unit 191 can acquire location information regarding an external mobile device, i.e., an azimuth of 92° E and a distance of 7 m. The external mobile device location information acquiring unit 191 calculates azimuths and distances for all external mobile devices that transmitted their current locations to the mobile device 100.

The external mobile device location information acquiring unit 191 then stores the calculated azimuths and distances in the external mobile device location information storage unit 151 (block 307). The external mobile device location information storage unit 151 stores azimuths and distances according to the identification information regarding external mobile devices.

In an embodiment, the external mobile device location information acquiring unit 191 may transmit a location information request message 401 to at least one external mobile device currently connected to the mobile device 100, in a polling mode. Because locations of the mobile device 100 and external mobile devices may differ in real-time, the external mobile device location information acquiring unit 191 can periodically transmit a location information request message 401 to external mobile devices currently connected to the mobile device 100. When the external mobile devices receive a location information request message 401, they measure the current locations and then transmit them to the mobile device 100.

Alternatively, external mobile devices may periodically measure their current locations and then transmit them to the mobile device 100. After the external mobile devices have transmitted their first current locations to the mobile device 100, they can periodically measure their current locations and transmit them to the mobile device 100 while they are connected to the mobile device 100.

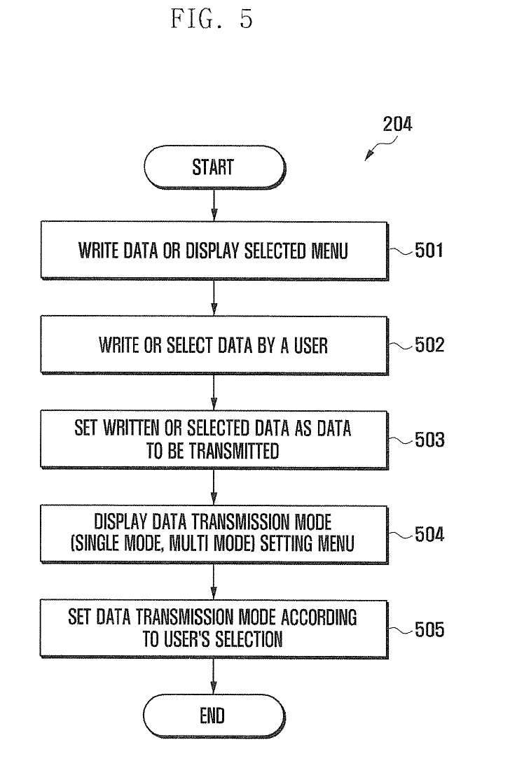

FIG. 5 illustrates a process for setting a data transmission mode and data to be transmitted (block 204 of FIG. 2), according to an embodiment of the invention.

The data setting unit 192 controls the display unit 180 to display a data writing menu or a data selecting menu (block 501). In an embodiment of the invention, the data writing menu refers to a menu that provides interfaces through which the user can directly create data. Examples of the data writing menu are a message writing menu, an email writing menu, a camera-photographing menu, and such. The data selecting menu refers to a menu that displays data written by the user or downloaded from external systems and provides interfaces through which the user can select corresponding data. Examples of the data selecting menu are a message box, a note menu, a photograph album menu, a video menu, an audio menu, and such.

After selecting a data writing menu or a data selecting menu at block 501, the data setting unit 192 detects that the user has written or selected data (block 502) The user can directly create data via the data writing menu or select corresponding data stored in the memory via the data selecting menu. The data setting unit 192 detects, via the input unit 170, that the user has written or selected data.

The data setting unit 192 sets the data written or selected by the user as data to be transmitted (block 503). The data setting unit 192 controls the display unit 180 to display a data transmission mode setting menu (block 504). The data transmission mode setting menu includes a signal mode and a multi mode. In the single mode, the mobile device 100 transmits data to one external mobile device. In the multi mode, the mobile device 100 transmits data to a number of external mobile devices. The data setting unit 192 receives a signal to select a single or multi mode via the input unit 170. The data setting unit 192 sets a data transmission mode according to the user's selection (block 505).

FIG. 6 illustrates a process for setting a target mobile device to receive data (block 206 of FIG. 2), according to an embodiment of the invention.

The target mobile device setting unit 193 measures the strength level and the range of motion of the mobile device 100 via the motion sensing unit 160 (block 601). The target mobile device setting unit 193 controls the geomagnetic sensor 161 to measure the range of motion of the mobile device 100. The target mobile device setting unit 193 also controls the acceleration sensor 162 to measure the strength level of motion of the mobile device 100.

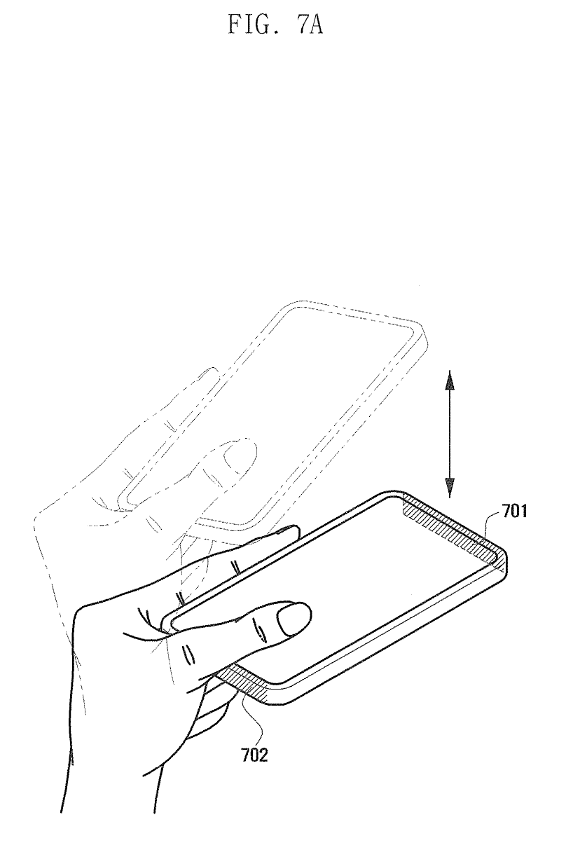

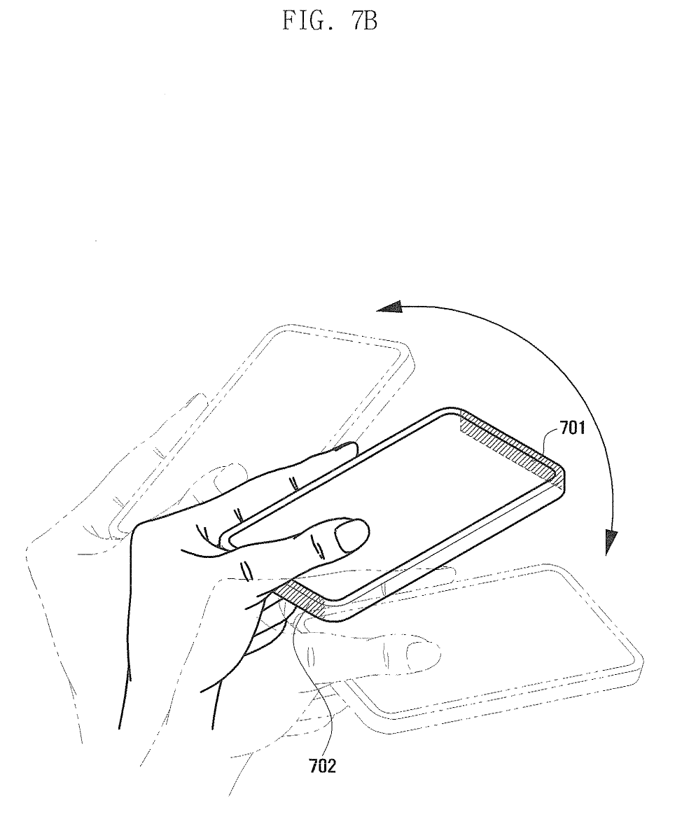

The target mobile device setting unit 193 determines whether the measured range of motion is equal to or greater than a preset azimuth range (block 602). In an embodiment of the invention, the ‘preset azimuth range’ refers to a value to distinguish between the motions, whether the user points to one external mobile device or a number of external mobile devices. The present azimuth range may be expressed by the degree of an angle, such as 10°, 20°, and so forth. The user can make a motion with the mobile device 100 to point to one external mobile device, as shown in FIG. 7A. For example, the user can vertically move the mobile device 100 up or down with the display unit 180 facing upwards. In that situation, because the top side 701 and the bottom side 702 of the mobile device 100, which are used to sense the terrestrial magnetism, are not moved in the horizontal direction, the mobile device 100 does not detect that its azimuth is altered.

Likewise, the user can make a motion with the mobile device 100 to point to a number of external mobile devices, as shown in FIG. 7B. That is, the user can horizontally move from side to side the mobile device 100 with the display unit 180 facing upwards. In that situation, because the top side 701 and the bottom side 702 of the mobile device 100 which are used to sense the terrestrial magnetism are moved in the horizontal direction, the mobile device 100 detects that its azimuth is altered.

In an embodiment of the invention, the preset azimuth range refers to a reference value to determine whether the user moves the top side of the mobile device 100 vertically or horizontally.

When the target mobile device setting unit 193 ascertains that the measured range of motion is less than a preset azimuth range at block 602, it detects an external mobile device in the measured range of motion (block 603). That is, the target mobile device setting unit 193 concludes that the user makes a motion to point out an external mobile device and detects external mobile devices in the measured range of motion.

The target mobile device setting unit 193 then determines whether there are two or more detected external mobile devices (block 604). For example, there may be two or more external mobile devices in the direction range where the user made a motion. In that situation, the target mobile device setting unit 193 detects two or more external mobile devices in the range of motion.

When the target mobile device setting unit 193 ascertains that the number of detected external mobile devices is two or more in the range of motion at block 604, it sets, as a target mobile device, the external mobile device located from a distance corresponding to the strength level of motion measured at block 601 (block 605).

In an embodiment of the invention, the storage unit 150 stores distance values matching strength levels of the movements. For example, strength levels of the movements 1, 2, and 3 match distance values ‘0˜3 m,’ ‘3˜5 m,’ and ‘5˜10 m,’ respectively. When the target mobile device setting unit 193 concludes that the movement corresponds to strength level 1 at block 601, it sets, as a target mobile device, an external mobile device located within 0˜3 m from the mobile device 100.

In contrast, when the target mobile device setting unit 193 ascertains that one external mobile devices is detected in the range of motion at block 604, it sets, as a target mobile device, the external mobile device determined at block 603 (606).

Meanwhile, when the target mobile device setting unit 193 ascertains that the measured range of motion is equal to or greater than a preset azimuth range at block 602, it determines whether the data transmission mode is set as a single mode or a multi mode (block 607). When the target mobile device setting unit 193 ascertains that the data transmission mode is set as a multi mode at block 607, it sets, as a target mobile device, at least one external mobile device in the range of motion (block 608).

In contrast, when the target mobile device setting unit 193 ascertains that the data transmission mode is set as a single mode at block 607, it sets, as a target mobile device, one of the external mobile devices determined at block 603 that is closest to the mobile device 100 (block 609).

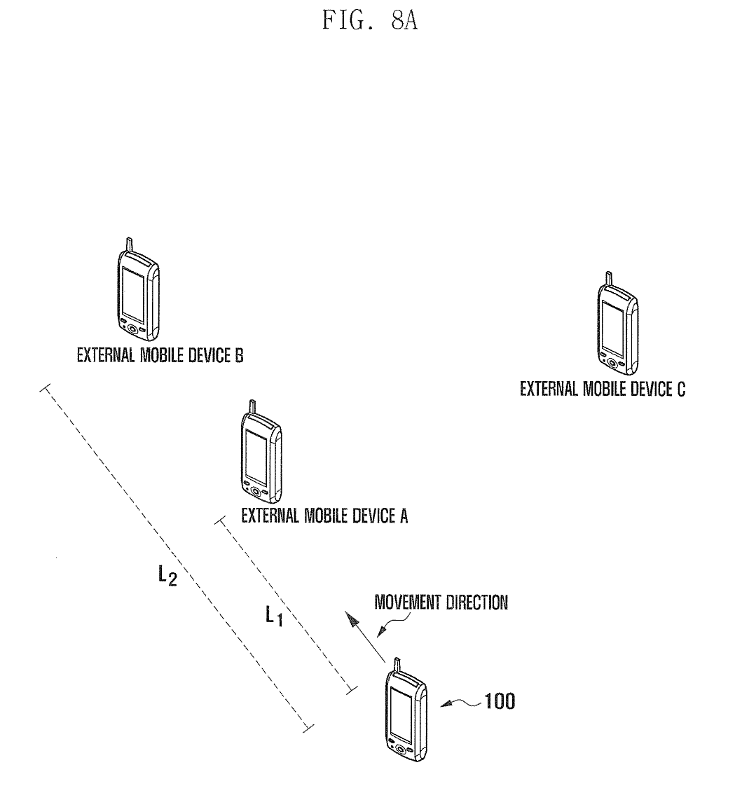

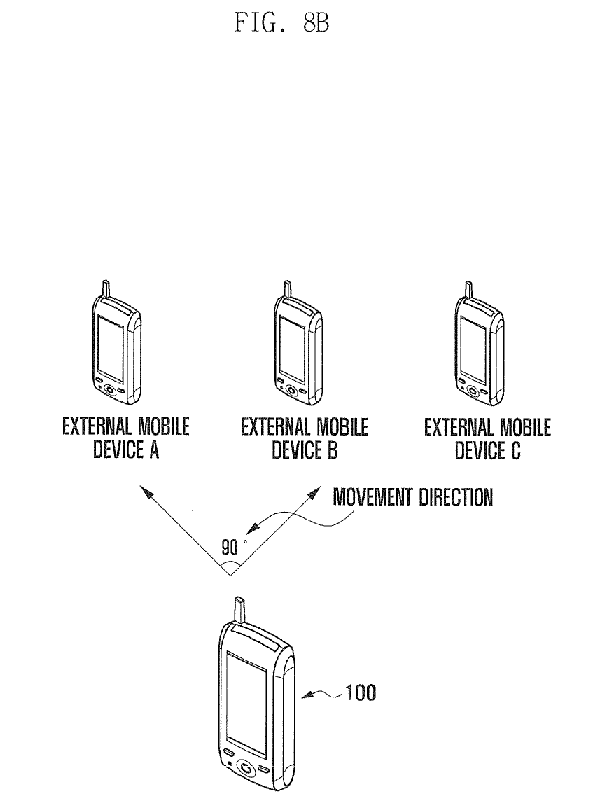

FIGS. 8A and 8B illustrate views that describe the process for setting a target mobile device according to the movement of a mobile device 100.

FIG. 8A shows a view in which the user makes a motion with the mobile device 100 to point to an external mobile device A. When the mobile device 100 receives a user's motion to point to an external mobile device A, the target mobile device setting unit 193 detects external mobile devices A and B in the range of motion. Because the target mobile device setting unit 193 detects multiple external mobile devices in the range of motion, it can set, as a target mobile device, an external mobile device located from a distance corresponding to the strength level applied to the mobile device 100. For example, it is assumed that distance values are ‘0˜3 m,’‘3˜5 m,’ and ‘5˜10 m’ corresponding to strength levels of motions 1, 2, and 3, respectively. When the measured motion is strength level 1, and distance L1 between the mobile device 100 and external mobile device A and distance L2 between the mobile device 100 and external mobile device B are 2 m and 4 m, respectively, the target mobile device setting unit 193 sets external mobile device A as a target mobile device. In contrast, when the strength level is 2, the target mobile device setting unit 193 sets external mobile device B as a target mobile device.

FIG. 8B shows a view in which the user makes a motion with the mobile device 100 to point to an external mobile device B. When the user swings the mobile device 100 90° from external mobile device A to B, the target mobile device setting unit 193 compares the range of motion with a preset azimuth range. When the preset azimuth range is set as 30°, the target mobile device setting unit 193 concludes that the range of motion is equal to or greater than the preset azimuth range. In addition, the target mobile device setting unit 193 determines whether the data transmission mode is a multi mode. When the target mobile device setting unit 193 ascertains that the data transmission mode is a multi mode, it sets, as target mobile devices, external mobile devices A and B. In contrast, when the target mobile device setting unit 193 ascertains that the data transmission mode is a single mode, it sets, as a target mobile device, one of the external mobile devices A and B that is closest to the mobile device 100.

As described above, the data transmission method and system, according to the invention, can allow users to easily transmit data via their mobile devices. The data transmission method and system can also allow users to directly input the movement in the direction towards a called party to receive data to their mobile devices, thereby enhancing the intuitive use of their mobile devices.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting data in a mobile device, the method comprising:
searching for external mobile devices near the mobile device;
acquiring location information for each external mobile device found near the mobile device;
setting data to be transmitted;
recognizing a movement of the mobile device;
setting at least one target mobile device from among the found external mobile devices to receive the data, based on the movement of the mobile device and the acquired location information of the found external mobile devices; and
transmitting the data to the at least one target mobile device.

2. The method of claim 1, wherein acquiring the location information comprises:
connecting to at least one of the found external mobile devices;
transmitting a location information request message to the at least one external mobile device connected to the mobile device;
receiving the location information regarding a current location for each of the at least one external mobile device connected to the mobile device;
measuring a current location of the mobile device;
calculating a distance and an azimuth for each of the at least one external mobile device connected to the mobile device, based on the measured current location of the mobile device; and
storing the calculated distance and azimuth.

3. The method of claim 2, wherein setting the data to be transmitted comprises:
displaying a data writing menu;
setting data entered by a user as the data to be transmitted;
displaying a data transmission mode setting menu including a single mode and a multi mode; and
setting the data transmission mode as one of the single mode and the multi mode, according to a user's selection.

4. The method of claim 3, wherein setting the at least one target mobile device comprises:
measuring a direction of motion of the mobile device; and
setting, as the at least one target mobile device, at least one of the found external mobile devices that is in the measured direction of motion.

5. The method of claim 3, wherein setting the at least one target mobile device comprises:
measuring a direction and a strength level of motion input by the user;
detecting at least one of the found external mobile devices in the measured direction of motion;
when more than one of the found external mobile devices are detected and the mobile device is in a single mode, setting one of the found external mobile devices located at a distance corresponding to the measured strength level of motion as the at least one target mobile device; and
when one of the found external mobile devices is detected, setting the detected external mobile device as the at least one target mobile device.

6. The method of claim 3, wherein setting the at least one target mobile device comprises:
measuring a strength level and a range of motion input by the user;
determining whether the measured range of motion is not less than a preset azimuth range;
determining the data transmission mode when the measured range of motion is not less than a preset azimuth range; and
setting, as the at least one target mobile device, at least one of the found external mobile devices in the range of motion when the data transmission mode is set to the multi mode.

7. The method of claim 6, further comprising:
setting, as the at least one target mobile device, one of the found external mobile devices that is closest to the mobile device, when the data transmission mode is set to the single mode.

8. The method of claim 1, further comprising:
determining whether a data sharing mode of the mobile device is set to an active state; and
operating, when the data sharing mode is set to the active state, a short-range communication unit, a location measurement module, a geomagnetic sensor, and an acceleration sensor in the mobile device.

9. A mobile device comprising:
a short-range communication unit configured to search for external mobile devices near the mobile device, acquiring location information for each external mobile device found near the mobile device, and for transmitting data to at least one target mobile device;
a location measurement module configured to measure a current location of the mobile device;
a motion sensing unit configured to sense a movement of the mobile device; and
a controller configured to set the data to be transmitted, and set the at least one target mobile device from among the found external mobile devices to receive the data based on the movement of the mobile device and the acquired location information of the found external mobile devices.

10. The mobile device of claim 9, wherein the short-range communication unit is further configured to connect to at least one of the found external mobile devices, transmit a location information request message to the at least one external mobile device connected to the mobile device, and receive the location information regarding a current location for each of the at least one external mobile device connected to the mobile device, and
wherein the motion sensing unit is further configured to measure a current location of the mobile device calculate a distance and an azimuth for each of the at least one external mobile device connected to the mobile device based on the measured current location of the mobile device, and store the calculated distance and azimuth in a storage unit.

11. The mobile device of claim 10, further comprising a display unit, wherein the controller is further configured to display a data writing menu on the display unit, set data entered by a user as the data to be transmitted, display a data transmission mode setting menu including a single mode and a multi mode on the display, and set the data transmission mode as one of the single mode and the multi mode, according to a user's selection.

12. The mobile device of claim 11, wherein the motion sensing unit comprises:
a geomagnetic sensor configured to measure a direction of motion of the mobile device; and
an acceleration sensor configured to measure a strength level of motion of the mobile device.

13. The mobile device of claim 9, wherein the short-range communication unit comprises at least one of a Bluetooth communication module, a WiFi communication module, a Zigbee communication module, an infrared communication module, a Near Field Communication (NFC) communication module, and a Radio Frequency Identification (RFID) communication module.

14. The mobile device of claim 12, wherein the controller is further configured to set at least one of the found external mobile devices that is in the measured direction of motion as the at least one target mobile device.

15. The mobile device of claim 9, wherein the controller comprises a data setting unit configured to set the data transmission mode as one of the single mode and the multi mode.

16. The mobile device of claim 12, wherein the controller comprises a target mobile device setting unit configured to detect external mobile devices in the measured direction of motion, set one of the found external mobile devices located at a distance corresponding to the measured strength level of motion as one of the at least one target mobile device when more than one of the found external mobile devices are detected and the mobile device is in a single mode, and set the detected external mobile device as the at least one target mobile device when one of the found external mobile devices is detected.

17. The mobile device of claim 15, wherein the motion sensing unit is further configured to measure a range of motion of the mobile device.

18. The mobile device of claim 17, wherein the controller comprises a target mobile device setting unit configured to determine whether the measured range of motion is not less than a preset azimuth range, determine when the data transmission mode when the measured range of motion is equal not less than a preset azimuth range, and set, as the at least one target mobile device, at least one of the found external mobile devices in the range of motion when the data transmission mode is set to the multi mode.

19. The mobile device of claim 18, wherein the target mobile device setting unit is further configured to set, as the at least one target mobile device, one of the found external mobile devices that is closest to the mobile device, when the data transmission mode is set to the single mode.

20. The mobile device of claim 8, wherein the controller is further configured to determine whether a data sharing mode of the mobile device is set to an active state, and operate the location measurement module, the geomagnetic sensor, and the acceleration sensor when the data sharing mode is set to the active state.
